(19) United States
(12) Patent Application Publication
(10) Pub. No.: US 2018/0071991 A1
(43) Pub. Date: Mar. 15, 2018

(54) Processing for Producing Flexible Container with Fitment Using Expandable Mandrel

(71) Applicant: Dow Global Technologies LLC, Midland, MI (US)

(72) Inventors: Kenneth R. Wilkes, Asheville, NC (US); Ryan S. Gaston, Freeport, TX (US)

(21) Appl. No.: 15/564,614

(22) PCT Filed: Apr. 6, 2016
(86) PCT No.: PCT/US2016/026109

§ 371 Date: Oct. 5, 2017

Related U.S. Application Data
(60) Provisional application No. 62/146,002, filed on Apr. 10, 2015.

(51) Int. Cl. B29C 65/18; B29C 65/00

(52) U.S. Cl. CPC B29C 65/18; B29K 2023/12; B29C 66/3452; B29C 66/43; B29C 66/53262; B29C 66/634; B29C 66/91421; B29C 66/83221; B29C 66/81463; B29C 66/723; B29C 66/81411; B29C 66/91935; B29C 66/7234; B29C 66/72321; B29C 66/71; B29C 66/73116

(57) ABSTRACT

The present disclosure provides a process for producing a flexible container. In an embodiment, the process includes (A) providing a flexible container. The flexible container has (i) a body, and (ii) a neck. The process includes (B) positioning a fitment into the neck. The fitment has a top portion and a base. The fitment is composed of a polymeric material. The process includes (C) inserting a mandrel into the fitment. The mandrel includes an expandable collar composed of an elastomeric material. The process includes (D) expanding the collar radially outward to contact an inner surface of the base. The process includes (E) sealing, with a pair of opposing seal bars, the base to the neck.

### BACKGROUND

The present disclosure is directed to a process for producing a flexible container with a dispensing fitment and a standup flexible container with a dispensing fitment in particular.

Flexible packaging is known to offer significant value and sustainability benefits to product manufacturers, retailers and consumers as compared to solid, molded plastic packaging containers. Flexible packaging provides many consumer conveniences and benefits, including extended shelf life, easy storage, microwavability and refillability. Flexible packaging has proven to require less energy for creation and creates fewer emissions during disposal.

Flexible packaging includes flexible containers with a gusseted body section. These gusseted flexible containers are currently produced using flexible films which are folded to form gussets and heat sealed in a perimeter shape. The gusseted body section opens to form a flexible container with a square cross section or a rectangular cross section. The gussets are terminated at the bottom of the container to form a substantially flat base, providing stability when the container is partially or wholly filled. The gussets are also terminated at the top of the container to form an open neck for receiving a rigid fitment and closure.

Conventional procedures for fabricating gusseted flexible containers with a rigid fitment have shortcomings. The fitment requires a material and a thickness strong enough to withstand the heat and compression force imparted by opposing seal bars during the sealing process. The fitment material must also be compatible with the container film material in order to form a heat seal weld.

Fitments with a canoe-shaped base or a base with extended radial fins oriented 180° apart are not practical for flexible containers with more than two panels because the base geometry of these fitments does not match the geometry of containers with three, four, or more panels.

A need exists for a process of producing a gusseted flexible container that does not deform or mis-shape the fitment during installation. A need further exists for a process of producing a gusseted flexible container with a thin-wall fitment and/or a flexible fitment.

### SUMMARY

The present disclosure provides a process for producing a flexible container. In an embodiment, the process includes (A) providing a flexible container. The flexible container has (i) a body, and (ii) a neck. The process includes (B) positioning a fitment into the neck. The fitment has a top portion and a base. The fitment is composed of a polymeric material. The process includes (C) inserting a mandrel into the fitment. The mandrel includes an expandable collar composed of an elastomeric material. The process includes (D) expanding the collar radially outward to contact an inner surface of the base. The process includes (E) sealing, with a pair of opposing seal bars, the base to the neck.

An advantage of the present disclosure is a process for hermetically sealing a fitment to the neck of a flexible container and reducing wrinkling at the fitment seal.

An advantage of the present disclosure is a production process that does not deform, distort, or damage the fitment during the sealing to the flexible container.

An advantage of the present disclosure is a flexible container with improved seal strength between the fitment and the flexible container panels.

An advantage of the present disclosure is a process which maintains the shape of the fitment during installation.

An advantage of the present disclosure is the production of a flexible container with a fitment made with a reduced amount of polymeric material.

An advantage of the present disclosure is a process for the production of a flexible container with a thin-wall fitment.

### BRIEF DESCRIPTION OF THE DRAWINGS

FIG. 1 is a front elevation view of a flexible container in a collapsed configuration in accordance with an embodiment of the present disclosure.

FIG. 2 is an exploded side elevation view of a panel sandwich.

FIG. 3 is a perspective view of the flexible container of FIG. 1 in an expanded configuration and in accordance with an embodiment of the present disclosure.

FIG. 4 is a bottom plan view of the expanded flexible container of FIG. 3 in accordance with an embodiment of the present disclosure.

FIG. 5 is a top plan view of the flexible container of FIG. 3.

FIG. 6 is an enlarged view of area 6 of FIG. 1.

FIG. 7 is an elevation view of a fitment in accordance with an embodiment of the present disclosure.

FIG. 7A is a bottom plan view of the fitment taken along line 7A-7A of FIG. 7.

FIG. 7B is a perspective view of the fitment inserted into the flexible container in accordance with an embodiment of the present disclosure.

FIG. 8 is a perspective view of a sealing apparatus with a mandrel having an expandable collar being inserted into the fitment in accordance with an embodiment of the present disclosure.

FIG. 8A is an exploded view of the mandrel in FIG. 8.

FIG. 9 is a perspective view of the sealing apparatus with the mandrel inserted into the fitment of the flexible container in accordance with an embodiment of the present disclosure.

FIG. 10A is a sectional view of the mandrel taken along line 10A-10A of FIG. 9.

FIG. 10B is a front elevation view of the mandrel taken along line 10B-10B of FIG. 10A, in accordance with an embodiment of the present disclosure.

FIG. 10C is a view of the mandrel of FIG. 10A with the expandable collar radially expanded.

FIG. 10D is a front elevation view of the mandrel taken along line 10D-10D of FIG. 10C.

FIG. 10E is a view of the mandrel of 10A with the expandable collar radially expanded.

FIG. 10F is a front elevation view of the mandrel taken along line 10F-10F of FIG. 10E.

FIG. 11 is a perspective view of a first sealing procedure in accordance with an embodiment of the present disclosure.

FIG. 11A is an enlarged front elevation view of the mandrel, fitment, neck, and seal bars of FIG. 11.

FIG. 12 is a perspective view of a second sealing procedure in accordance with an embodiment of the present disclosure.

FIG. 12A is an enlarged front elevation view of the mandrel, fitment, neck, and seal bars of FIG. 12.

FIG. 13A is a sectional view of the mandrel and fitment after the second sealing step and in accordance with an embodiment of the present disclosure.

FIG. 13B is a sectional view of the mandrel and fitment after the second sealing step and in accordance with an embodiment of the present disclosure.

FIG. 14 is a perspective view of the flexible container with the fitment installed in the flexible container in accordance with an embodiment of the present disclosure.

### DETAILED DESCRIPTION

The present disclosure provides a process for producing a flexible container. In an embodiment, the process includes (A) providing a flexible container. The flexible container has (i) a body, and (ii) a neck. The process includes (B) positioning a fitment into the neck. The fitment has a top portion and a base. The fitment is composed of a polymeric material. The process includes (C) inserting a mandrel into the fitment. The mandrel includes an expandable collar composed of an elastomeric material. The process includes (D) expanding the collar radially outward to contact an inner surface of the base. The process includes (E) sealing, with a pair of opposing seal bars, the base to the neck.

1. Flexible Container

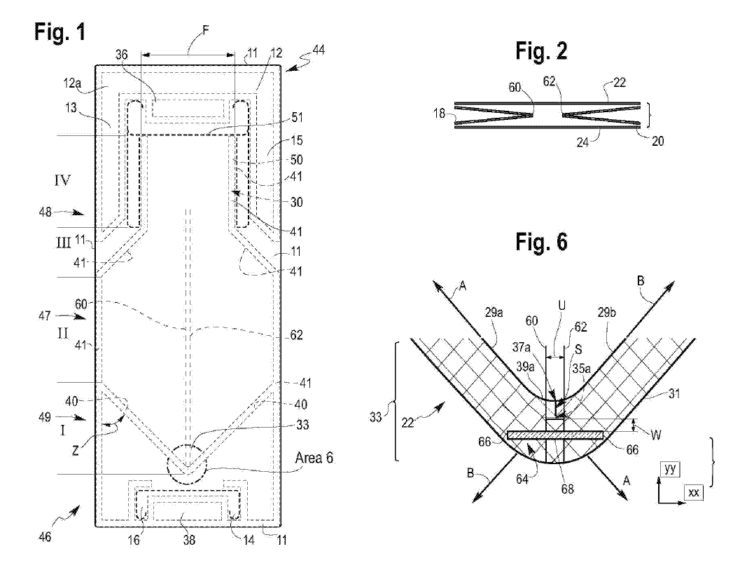

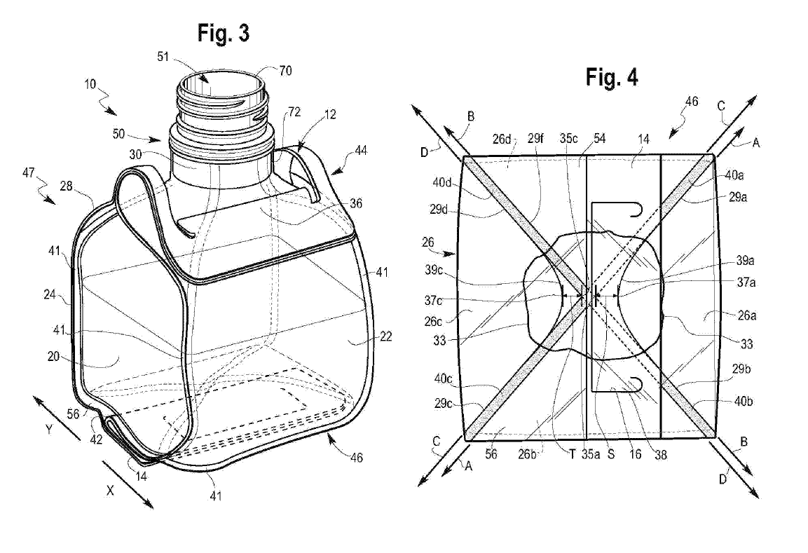

The process includes providing a flexible container. The flexible container can be made from two, three, four, five, six, or more panels. Each panel is composed of a flexible multilayer film. In an embodiment, the flexible container 10 has a collapsed configuration (as shown in FIG. 1) and has an expanded configuration (shown in FIGS. 3, 4, 5). FIG. 1 shows the flexible container 10 having a bottom section I, a body section II, a tapered transition section III, and a neck section IV. In the expanded configuration, the bottom section I forms a bottom segment 26, as shown in FIG. 4. The body section II forms a body portion. The tapered transition section III forms a tapered transition portion. The neck section IV forms a neck portion.

In an embodiment, the flexible container 10 is made from four panels as shown in FIGS. 1-6. During the fabrication process, the panels are formed when one or more webs of film material are sealed together. While the webs may be separate pieces of film material, it will be appreciated that any number of the seams between the webs could be “pre-made,” as by folding one or more of the source webs to create the effect of a seam or seams. For example, if it were desired to fabricate the present flexible container from two webs instead of four, the bottom, left center, and right center webs could be a single folded web, instead of three separate webs. Similarly, one, two, or more webs may be used to produce each respective panel (i.e., a bag-in-a-bag configuration or a bladder configuration).

FIG. 2 shows the relative positions of the four webs as they form four panels (in a “one up” configuration) as they pass through the fabrication process. For clarity, the webs are shown as four individual panels, the panels separated and the heat seals not made. The constituent webs form first gusset panel 18, second gusset panel 20, front panel 22 and rear panel 24. The panels 18-24 are a multilayer film as discussed in detail below. The gusset fold lines 60 and 62 are shown in FIGS. 1 and 2.

As shown in FIG. 2, the folded gusset panels 18, 20 are placed between the rear panel 24 and the front panel 22 to form a “panel sandwich.” The gusset panel 18 opposes the gusset panel 20. The edges of the panels 18-24 are configured, or otherwise arranged, to form a common periphery 11 as shown in FIG. 1. The flexible multilayer film of each panel web is configured so that the heat seal layers face each other. The common periphery 11 includes the bottom seal area including the bottom end of each panel.

When the flexible container 10 is in the collapsed configuration, the flexible container is in a flattened state, or in an otherwise evacuated state. The gusset panels 18, 20 fold inwardly (dotted gusset fold lines 60, 62 of FIG. 1) and are sandwiched by the front panel 22 and the rear panel 24.

FIGS. 3-5 show flexible container 10 in the expanded configuration. The flexible container 10 has four panels, a front panel 22, a rear panel 24, a first gusset panel 18 and a second gusset panel 20. The four panels 18, 20, 22, and 24 form the body section II and extend toward a top end 44 and extend toward a bottom end 46 of the container 10. Sections III and IV (respective tapered transition section, neck section) form a top segment 28. Section I (bottom section) forms a bottom segment 26.

The four panels 18, 20, 22 and 24 can each be composed of a separate web of film material. The composition and structure for each web of film material can be the same or different. Alternatively, one web of film material may also be used to make all four panels and the top and bottom segments. In a further embodiment, two or more webs can be used to make each panel.

In an embodiment, four webs of film material are provided, one web of film for each respective panel 18, 20, 22, and 24. The process includes sealing edges of each film to the adjacent web of film to form peripheral seals 41 and peripheral tapered seals 40a-40d (40) (FIGS. 1, 3, 4, 5). The peripheral tapered seals 40a-40d are located on the bottom segment 26 of the container as shown in FIG. 4, and have an inner edge 29a-29f. The peripheral seals 41 are located on the side edges of the container 10, as shown in FIG. 3. Consequently, the process includes forming a closed bottom section I, a closed body section II, and a closed tapered transition section III.

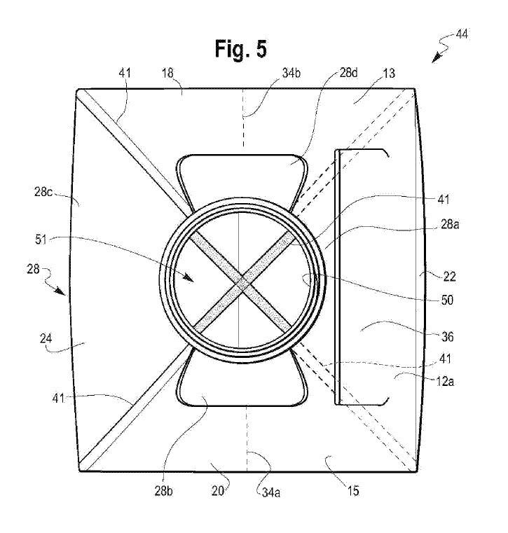

To form the top segment 28 and the bottom segment 26, the four webs of film converge together at the respective end and are sealed together. For instance, the top segment 28 can be defined by extensions of the panels sealed together at the tapered transition section III, and the neck section IV. The top end 44 includes four top panels 28a-28d (FIG. 5) of film that define the top segment 28. The bottom segment 26 can be defined by extensions of the panels sealed together at the bottom section I. The bottom segment 26 can also have four bottom panels 26a-26d of film sealed together and can also be defined by extensions of the panels at the opposite end 46 as shown in FIG. 4.

The neck portion can be located at a corner of the body 47, or in one of the four panels. In an embodiment, the neck 30 is positioned at a midpoint of the top segment 28. The neck 30 may (or may not) be sized smaller than a width of the body section II, such that the neck 30 can have an area that is less than a total area of the top segment 28. The location of the neck 30 can be anywhere on the top segment 28 of the container 10.

In an embodiment, the neck is formed from two or more panels. In a further embodiment, the neck 30 is formed from four panels.

In an embodiment, the neck is sized to accommodate a wide-mouth fitment. A “wide-mouth fitment,” is a fitment having a diameter greater than 50 mm.

Although FIGS. 1 and 3 show the flexible container 10 with a top handle 12 and a bottom handle 14, it is understood the flexible container 10 may be fabricated without handles or with only one handle. When the flexible container 10 has a top handle 12, the neck 30 is located centered on the top segment 28 between the handle bases to facilitate easy pouring.

The four panels of film that form the flexible container 10 extend from the body section II (forming body 47), to the tapered transition section III (forming tapered transition portion 48), to form a neck 30 (in the neck section IV). The four panels of film also extend from the body section II to the bottom section I (forming bottom portion 49). When the flexible container 10 is in the collapsed configuration (FIG. 1), the neck 30 has a width F that is less than the width of the tapered transition section III. The neck 30 includes a neck wall 50. FIGS. 1 and 3 show the neck wall 50 forms an open end 51 for access into the flexible container interior. The panels are sealed together to form a closed bottom section I, a closed body section II, and a closed tapered transition section III. Nonlimiting examples of suitable heating procedures include heat sealing and/or ultrasonic sealing. When the flexible container 10 is in the expanded configuration, the open end 51 of the neck wall 50 is open or is otherwise unsealed. When the flexible container 10 is in the collapsed configuration, the open end 51 is unsealed and is openable. The open end 51 permits access to the container interior through the neck wall 50 and the neck 30 as shown in FIGS. 3 and 5.

As shown in FIGS. 1 and 3-4, the flexible bottom handle 14 can be positioned at a bottom end 46 of the container 10 such that the bottom handle 14 is an extension of the bottom segment 26.

Each panel includes a respective bottom face. FIG. 4 shows four triangle-shaped bottom faces 26a-26d, each bottom face being an extension of a respective film panel. The bottom faces 26a-26d make up the bottom segment 26. The four panels 26a-26d come together at a midpoint of the bottom segment 26. The bottom faces 26a-26d are sealed together, such as by using a heat-sealing technology, to form the bottom handle 14. For instance, a weld can be made to form the bottom handle 14, and to seal the edges of the bottom segment 26 together. Nonlimiting examples of suitable heat-sealing technologies include hot bar sealing, hot die sealing, impulse sealing, high frequency sealing, or ultrasonic sealing methods.

FIG. 4 shows bottom segment 26. Each panel 18, 20, 22, 24 has a respective bottom face 26a-26d that is present in the bottom segment 26. Each bottom face is bordered by two opposing peripheral tapered seals 40a-40d. Each peripheral tapered seal 40a-40d extends from a respective peripheral seal 41. The peripheral tapered seals for the front panel 22 and the rear panel 24 have an inner edge 29a-29d (FIG. 4) and an outer edge 31 (FIG. 6). The peripheral tapered seals 40a-40d converge at a bottom seal area 33 (FIG. 1, FIG. 4, FIG. 6).

The front panel bottom face 26a includes a first line A defined by the inner edge 29a of the first peripheral tapered seal 40a and a second line B defined by the inner edge 29b of the second peripheral tapered seal 40b. The first line A intersects the second line B at an apex point 35a in the bottom seal area 33. The front panel bottom face 26a has a bottom distalmost inner seal point 37a (“BDISP 37a”). The BDISP 37a is located on the inner edge.

The apex point 35a is separated from the BDISP 37a by a distance S from 0 millimeter (mm) to less than 8.0 mm.

In an embodiment, the rear panel bottom face 26c includes an apex point 35c similar to the apex point 35a on the front panel bottom face 26a. The rear panel bottom face 26c includes a first line C defined by the inner edge of the 29c first peripheral tapered seal 40c and a second line D defined by the inner edge 29d of the second peripheral tapered seal 40d. The first line C intersects the second line D at an apex point 35c in the bottom seal area 33. The rear panel bottom face 26c has a bottom distalmost inner seal point 37c (“BDISP 37c”). The BDISP 37c is located on the inner edge. The apex point 35c is separated from the BDISP 37c by a distance T from 0 millimeter (mm) to less than 8.0 mm.

It is understood the following description to the front panel bottom face 26a applies equally to the rear panel bottom face 26c, with reference numerals to the rear panel bottom face 26c shown in adjacent closed parentheses.

In an embodiment, the BDISP 37a (37c) is located where the inner edges 29a (29c) and 29b (29d) intersect. The distance S (distance T) between the BDISP 37a (37c) and the apex point 35a (35c) is 0 mm.

In an embodiment, the inner seal edge diverges from the inner edges 29a, 29b (29c, 29d), to form an inner seal arc 39a (front panel) and inner seal arc 39c (rear panel) as shown in FIGS. 4 and 6. The BDISP 37a (37c) is located on the inner seal arc 39a (39c). The apex point 35a (35c) is separated from the BDISP 37a (37c ) by the distance S (distance T), which is from greater than 0 mm, or 0.5 mm, or 1.0 mm, or 2.0 mm, or 2.6 mm, or 3.0 mm, or 3.5 mm, or 3.9 mm to 4.0 mm, or 4.5 mm, or 5.0 mm, or 5.2 mm, or 5.3 mm, or 5.5 mm, or 6.0 mm, or 6.5 mm, or 7.0 mm, or 7.5 mm, or 7.9 mm.

In an embodiment, apex point 35a (35c) is separated from the BDISP 37a (37c) by the distance S (distance T) which is from greater than 0 mm to less than 6.0 mm.

In an embodiment, the distance S (distance T) from the apex point 35a (35c) to the BDISP 37a (37c ) is from greater than 0 mm, or 0.5 mm, or 1.0 mm, or 2.0 mm to 4.0 mm or 5.0 mm or less than 5.5 mm.

In an embodiment, apex point 35a (35c) is separated from the BDISP 37a (37c) by the distance S (distance T), which is from 3.0 mm, or 3.5 mm, or 3.9 mm to 4.0 mm, or 4.5 mm, or 5.0 mm, or 5.2 mm, or 5.3 mm, or 5.5 mm.

In an embodiment, the distal inner seal arc 39a (39c) has a radius of curvature from 0 mm, or greater than 0 mm, or 1.0 mm to 19.0 mm, or 20.0 mm.

In an embodiment, each peripheral tapered seal 40a-40d (outside edge) and an extended line from respective peripheral seal 41 (outside edge) form an angle Z, as shown in FIG. 1. The angle Z is from 40°, or 42°, or 44°, or 45° to 46°, or 48°, or 50°. In an embodiment, angle Z is 45°.

The bottom segment 26 includes a pair of gussets 54 and 56 formed there at, which are essentially extensions of the bottom faces 26a-26d. The gussets 54 and 56 can facilitate the ability of the flexible container 10 to stand upright. These gussets 54 and 56 are formed from excess material from each bottom face 26a-26d that are joined together to form the gussets 54 and 56. The triangular portions of the gussets 54 and 56 comprise two adjacent bottom segment panels sealed together and extending into its respective gusset. For example, adjacent bottom faces 26a and 26d extend beyond the plane of their bottom surface along an intersecting edge and are sealed together to form one side of a first gusset 54. Similarly, adjacent bottom faces 26c and 26d extend beyond the plane of their bottom surface along an intersecting edge and are sealed together to form the other side of the first gusset 54. Likewise, a second gusset 56 is similarly formed from adjacent bottom faces 26a-26b and 26b-26c. The gussets 54 and 56 can contact a portion of the bottom segment 26, where the gussets 54 and 56 can contact bottom faces 26b and 26d covering them, while bottom segment panels 26a and 26c remain exposed at the bottom end 46.

As shown in FIGS. 3-4, the gussets 54 and 56 of the flexible container 10 can further extend into the bottom handle 14. In the aspect where the gussets 54 and 56 are positioned adjacent to bottom segment panels 26b and 26d, the bottom handle 14 can also extend across bottom faces 26b and 26d, extending between the pair of panels 18 and 20. The bottom handle 14 can be positioned along a center portion or midpoint of the bottom segment 26 between the front panel 22 and the rear panel 24.

The top handle 12 and the bottom handle 14 can comprise up to four plys of film sealed together for a four panel container 10. When more than four panels are used to make the container, the handles 12, 14 can include the same number of panels used to produce the container. Any portion of the handles 12, 14 where all four plys are not completely sealed together by the heat-sealing method, can be adhered together in any appropriate manner, such as by a tack seal to form a fully-sealed multilayer handle. Alternatively, the top handle 12 can be made from as few as a single ply of film from one panel only or can be made from only two plies of film from two panels. The handles 12, 14 can have any suitable shape and generally will take the shape of the film end. For example, typically the web of film has a rectangular shape when unwound, such that its ends have a straight edge. Therefore, the handles 12, 14 would also have a rectangular shape.

Additionally, the bottom handle 14 can contain a handle opening 16 or cutout section therein sized to fit a user's hand, as can be seen in FIG. 1. The handle opening 16 can be any shape that is convenient to fit the hand and, in one aspect, the handle opening 16 can have a generally oval shape. In another embodiment, the handle opening 16 can have a generally rectangular shape. Additionally, the handle opening 16 of the bottom handle 14 can also have a flap 38 that comprises the cut material that forms the handle opening 16. To define the handle opening 16, the bottom handle 14 can have a section that is cut out of the multilayer bottom handle 14 along three sides or portions while remaining attached at a fourth side or lower portion. This provides a flap of material 38 that can be pushed through the handle opening 16 by the user and folded over an edge of the handle opening 16 to provide a relatively smooth gripping surface at an edge that contacts the user's hand. If the flap of material 38 were completely cut out, this would leave an exposed fourth side or lower edge that could be relatively sharp and could possibly cut or scratch the hand when placed there.

Furthermore, a portion of the bottom handle 14 attached to the bottom segment 26 can contain a dead machine fold 42 or a score line that provides for the bottom handle 14 to consistently fold in the same direction, as illustrated in FIG. 3. The machine fold 42 can comprise a fold line that permits folding in a first direction X toward the front panel 22 and restricts folding in a second direction Y toward the rear panel 24. The term “restricts” as used throughout this application can mean that it is easier to move in one direction, or the first direction, than in an opposite direction, such as the second direction. The machine fold 42 can cause the bottom handle 14 to consistently fold in the first direction because it can be thought of as providing a generally permanent fold line in the bottom handle 14 that is predisposed to fold in the first direction X, rather than in the second direction Y. This machine fold 42 of the bottom handle 14 can serve multiple purposes, one being that when a user is transferring the product from the container 10 they can grasp the bottom handle 14 and it will easily bend in the first direction X to assist in pouring. Secondly, when the flexible container 10 is stored in an upright position, the machine fold 42 in the bottom handle 14 encourages the bottom handle 14 to fold in the first direction X along the machine fold 42, such that the bottom handle 14 can fold underneath the container 10 adjacent one of the bottom segment panels 26a, as shown in FIG. 4. The weight of the product can also apply a force to the bottom handle 14, such that the weight of the product can further press on the bottom handle 14 and maintain the bottom handle 14 in the folded position in the first direction X. As will be discussed herein, the top handle 12 can also contain a similar machine fold 34a, 34b that also allows it to fold consistently in the same first direction X as the bottom handle 14.

Additionally, as the flexible container 10 is evacuated and less product remains, the bottom handle 14 can continue to provide support to help the flexible container 10 to remain standing upright unsupported and without tipping over. Because the bottom handle 14 is sealed generally along its entire length extending between the pair of gusset panels 18 and 20, it can help to keep the gussets 54 and 56 (FIGS. 3, 4) together and continue to provide support to stand the container 10 upright even as the container 10 is emptied.

As seen in FIGS. 1, 3, and 5, the top handle 12 can extend from the top segment 28 and, in particular, can extend from the four panels 28a-28d that make up the top segment 28. The four panels 28a-28d of film that extend into the top handle 12 are all sealed together to form a multilayer top handle 12. The top handle 12 can have a U-shape and, in particular, an upside down U-shape with a horizontal upper handle portion 12a having two pairs of spaced legs 13 and 15 extending therefrom. The pair of legs 13 and 15 extend from the top segment 28, adjacent the neck 30.

A portion of the top handle 12 can extend above the neck 30 and above the top segment 28 when the top handle 12 is extended in a position perpendicular to the top segment 28 and, in particular, the entire upper handle portion 12a can be above the neck wall 50 and the top segment 28. The two pairs of legs 13 and 15 along with the upper handle portion 12a together make up the top handle 12 surrounding a handle opening that allows a user to place their hand therethrough and grasp the upper handle portion 12a of the handle 12.

As with the bottom handle 14, the top handle 12 also can have a dead machine fold 34a, 34b that permits folding in a first direction toward the front side panel 22 and restricts folding in a second direction toward the rear side panel 24, as shown in FIG. 5. The machine fold 34a, 34b can be located in each of the pair of legs 13, 15 at a location where the seal begins. The top handle 12 can be adhered together, such as with a tack adhesive, for example. The machine fold 34a, 34b in the top handle 12 can allow for the top handle 12 to be inclined to fold or bend consistently in the same first direction X as the bottom handle 14, rather than in the second direction Y. As shown in FIGS. 1, 3, and 5, the top handle 12 can likewise contain a flap portion 36, that folds upwards toward the upper handle portion 12a of the top handle 12 to create a smooth gripping surface of the top handle 12, as with the bottom handle 14, such that the handle material is not sharp and can protect the user's hand from getting cut on any sharp edges of the top handle 12.

When the container 10 is in a rest position, such as when it is standing upright on its bottom segment 26, as shown in FIG. 3, the bottom handle 14 can be folded underneath the container 10 along the bottom machine fold 42 in the first direction X, so that it is parallel to the bottom segment 26 and adjacent bottom panel 26a, and the top handle 12 will automatically fold along its machine fold 34a, 34b in the same first direction X, with a front surface of the top handle 12 parallel to a panel 28a of the top segment 28. The top handle 12 folds in the first direction X, rather than extending straight up, perpendicular to the top segment 28, because of the machine fold 34a, 34b. Both handles 12 and 14 are inclined to fold in the same direction X, such that upon dispensing, the handles can fold the same direction, relatively parallel to its respective end panel or end segment, to make dispensing easier and more controlled. Therefore, in a rest position, the handles 12 and 14 are both folded generally parallel to one another. Additionally, the container 10 can stand upright even with the bottom handle 14 positioned underneath the upright container 10.

The material of construction of the flexible container 10 can comprise food-grade plastic. For instance, nylon, polypropylene, polyethylene such as high density polyethylene (HDPE) and/or low density polyethylene (LDPE) may be used, as discussed later. The film of the plastic container 10 can have a thickness and barrier properties that are adequate to maintain product and package integrity during manufacturing, distribution, product shelf life and customer usage. In an embodiment, the flexible multilayer film has a thickness from 100 micrometers (μm), or 200 μm, or 250 μm to 300 μm, or 350 μm, or 400 μm. In an embodiment, the film material can also be such that it provides the appropriate atmosphere within the flexible container 10 to maintain the product shelf life of at least about 180 days. Such films can comprise an oxygen barrier film, such as a film having a low oxygen transmission rate (OTR) from greater than 0 to 0.4 cc/m²/atm/24 hrs at 23° C. and 80% relative humidity (RH). Additionally, the flexible multilayer film can also comprise a water vapor barrier film, such as a film having a low water vapor transmission rate (WVTR) from greater than 0 to 15 g/m²/24 hrs at 38° C. and 90% RH. Moreover, it may be desirable to use materials of construction having oil and/or chemical resistance particularly in the seal layer, but not limited to just the seal layer. The flexible multilayer film can be either printable or compatible to receive a pressure sensitive label or other type of label for displaying of indicia on the flexible container 10. In an embodiment the film can also be made of non-food grade resins for producing containers for materials other than food.

In an embodiment, each panel is made from a flexible multilayer film having at least one, or at least two, or at least three layers. The flexible multilayer film is resilient, flexible, deformable, and pliable. The structure and composition of the flexible multilayer film for each panel 18, 20, 22, 24 may be the same or different. For example, each of the four panels 18, 20, 22, 24 can be made from a separate web, each web having a unique structure and/or unique composition, finish, or print. Alternatively, each of the four panels 18, 20, 22, 24 can be the same structure and the same composition.

In an embodiment, each panel 18, 20, 22, 24 is a flexible multilayer film having the same structure and the same composition.

The flexible multilayer film may be (i) a coextruded multilayer structure or (ii) a laminate, or (iii) a combination of (i) and (ii). In an embodiment, the flexible multilayer film has at least three layers: a seal layer, an outer layer, and a tie layer between. The tie layer adjoins the seal layer to the outer layer. The flexible multilayer film may include one or more optional inner layers disposed between the seal layer and the outer layer.

In an embodiment, the flexible multilayer film is a coextruded film having at least two, or three, or four, or five, or six, or seven to eight, or nine, or ten, or eleven, or more layers. Some methods, for example, used to construct films are by cast co-extrusion or blown co-extrusion methods, adhesive lamination, extrusion lamination, thermal lamination, and coatings such as vapor deposition. Combinations of these methods are also possible. Film layers can comprise, in addition to the polymeric materials, additives such as stabilizers, slip additives, antiblocking additives, process aids, clarifiers, nucleators, pigments or colorants, fillers and reinforcing agents, and the like as commonly used in the packaging industry. It is particularly useful to choose additives and polymeric materials that have suitable organoleptic and/or optical properties.

In another embodiment, the flexible multilayer film can comprise a bladder wherein two or more films that are adhered in such a manner as to allow some delamination of one or more plies to occur during a significant impact such that the inside film maintains integrity and continues to hold contents of the container.

The flexible multilayer film is composed of a polymeric material. Nonlimiting examples of suitable polymeric materials for the seal layer include olefin-based polymer (including any ethylene/C₃-C₁₀ α-olefin copolymers linear or branched), propylene-based polymer (including plastomer and elastomer, random propylene copolymer, propylene homopolymer, and propylene impact copolymer), ethylene-based polymer (including plastomer and elastomer, high density polyethylene (“HDPE”), low density polyethylene (“LDPE”), linear low density polyethylene (“LLDPE”), medium density polyethylene (“MDPE”)), ethylene-acrylic acid or ethylene-methacrylic acid and their ionomers with zinc, sodium, lithium, potassium, magnesium salts, ethylene vinyl acetate copolymers and blends thereof.

Nonlimiting examples of suitable polymeric material for the outer layer include those used to make biaxially or monoaxially oriented films for lamination as well as coextruded films. Some nonlimiting polymeric material examples are biaxially oriented polyethylene terephthalate (OPET), monoaxially oriented nylon (MON), biaxially oriented nylon (BON), and biaxially oriented polypropylene (BOPP). Other polymeric materials useful in constructing film layers for structural benefit are polypropylenes (such as propylene homopolymer, random propylene copolymer, propylene impact copolymer, thermoplastic polypropylene (TPO) and the like, propylene-based plastomers (e.g., VERSIFY™ or VISTAMAX™)), polyamides (such as Nylon 6; Nylon 6,6; Nylon 6,66; Nylon 6,12; Nylon 12; etc.), polyethylene norbornene, cyclic olefin copolymers, polyacrylonitrile, polyesters, copolyesters (such as polyethylene terephthlate glycol-modified (PETG)), cellulose esters, polyethylene and copolymers of ethylene (e.g., LLDPE based on ethylene octene copolymer such as DOWLEX™), blends thereof, and multilayer combinations thereof.

Nonlimiting examples of suitable polymeric materials for the tie layer include functionalized ethylene-based polymers such as ethylene-vinyl acetate (EVA) copolymer, polymers with maleic anhydride-grafted to polyolefins such as any polyethylene, ethylene-copolymers, or polypropylene, and ethylene acrylate copolymers such an ethylene methyl acrylate (EMA) copolymer, glycidyl containing ethylene copolymers, propylene- and ethylene-based olefin block copolymers (OBC) such as INTUNE™ (PP-OBC) and INFUSE™ (PE-OBC), both available from The Dow Chemical Company, and blends thereof.

The flexible multilayer film may include additional layers which may contribute to the structural integrity or provide specific properties. The additional layers may be added by direct means or by using appropriate tie layers to the adjacent polymer layers. Polymers which may provide additional mechanical performance such as stiffness or opacity, as well polymers which may offer gas barrier properties or chemical resistance can be added to the structure.

Nonlimiting examples of suitable material for the optional barrier layer include copolymers of vinylidene chloride and methyl acrylate, methyl methacrylate or vinyl chloride (e.g., SARAN resins available from The Dow Chemical Company); vinylethylene vinyl alcohol (EVOH) copolymer; and metal foil (such as aluminum foil). Alternatively, modified polymeric films such as vapor deposited aluminum or silicon oxide on such films as BON, OPET, or oriented polypropylene (OPP), can be used to obtain barrier properties when used in laminate multilayer film.

In an embodiment, the flexible multilayer film includes a seal layer selected from LLDPE (sold under the trade name DOWLEX™ (The Dow Chemical Company)); single-site LLDPE; substantially linear, or linear ethylene alpha-olefin copolymers, including polymers sold under the trade name AFFINITY™ or ELITE™ (The Dow Chemical Company) for example; propylene-based plastomers or elastomers such as VERSIFY™ (The Dow Chemical Company); and blends thereof. An optional tie layer is selected from either ethylene-based olefin block copolymer PE-OBC (sold as INFUSE™) or propylene-based olefin block copolymer PP-OBC (sold as INTUNE™). The outer layer includes greater than 50 wt % of resin(s) having a melting point, Tm, that is from 25° C., to 30° C., or 40° C. higher than the melting point of the polymer in the seal layer, wherein the outer layer polymer is selected from resins such as VERSIFY™ or VISTAMAX™, ELITE™, HDPE or a propylene-based polymer such as propylene homopolymer, propylene impact copolymer or TPO.

In an embodiment, the flexible multilayer film is co-extruded.

In an embodiment, flexible multilayer film includes a seal layer selected from LLDPE (sold under the trade name DOWLEX™ (The Dow Chemical Company)); single-site LLDPE; substantially linear, or linear, olefin polymers, including polymers sold under the trade name AFFINITY™ or ELITE™ (The Dow Chemical Company) for example; propylene-based plastomers or elastomers such as VERSIFY™ (The Dow Chemical Company); and blends thereof. The flexible multilayer film also includes an outer layer that is a polyamide.

In an embodiment, the flexible multilayer film is a coextruded film and includes:

(i) a seal layer composed of an olefin-based polymer having a first melt temperature less than 105° C., (Tm1); and

(ii) an outer layer composed of a polymeric material having a second melt temperature, (Tm2),

wherein Tm2−Tm1>40° C.

The term “Tm2−Tm1” is the difference between the melt temperature of the polymer in the outer layer and the melt temperature of the polymer in the seal layer, and is also referred to as “ΔTm.” In an embodiment, the ΔTm is from 41° C., or 50° C., or 75° C., or 100° C. to 125° C., or 150° C., or 175° C., or 200° C.

In an embodiment, the flexible multilayer film is a coextruded film, the seal layer is composed of an ethylene-based polymer, such as a linear or a substantially linear polymer, or a single-site catalyzed linear or substantially linear polymer of ethylene and an alpha-olefin monomer such as 1-butene, 1-hexene or 1-octene, having a Tm from 55° C. to 115° C. and a density from 0.865 to 0.925 g/cm³, or from 0.875 to 0.910 g/cm³, or from 0.888 to 0.900 g/cm³ and the outer layer is composed of a polyamide having a Tm from 170° C. to 270° C.

In an embodiment, the flexible multilayer film is a coextruded and/or laminated film having at least five layers, the coextruded film having a seal layer composed of an ethylene-based polymer, such as a linear or substantially linear polymer, or a single-site catalyzed linear or substantially linear polymer of ethylene and an alpha-olefin comonomer such as 1-butene, 1-hexene or 1-octene, the ethylene-based polymer having a Tm from 55° C. to 115° C. and a density from 0.865 to 0.925 g/cm³, or from 0.875 to 0.910 g/cm³, or from 0.888 to 0.900 g/cm³ and an outermost layer composed of a material selected from LLDPE, OPET, OPP (oriented polypropylene), BOPP, polyamide, and combinations thereof.

In an embodiment, the flexible multilayer film is a coextruded and/or laminated film having at least seven layers. The seal layer is composed of an ethylene-based polymer, such as a linear or substantially linear polymer, or a single-site catalyzed linear or substantially linear polymer of ethylene and an alpha-olefin comonomer such as 1-butene, 1-hexene or 1-octene, the ethylene-based polymer having a Tm from 55° C. to 115° C. and density from 0.865 to 0.925 g/cm³, or from 0.875 to 0.910 g/cm³, or from 0.888 to 0.900 g/cm³. The outer layer is composed of a material selected from LLDPE, OPET, OPP (oriented polypropylene), BOPP, polyamide, and combinations thereof.

In an embodiment, the flexible multilayer film is a coextruded (or laminated) five layer film, or a coextruded (or laminated) seven layer film having at least two layers containing an ethylene-based polymer. The ethylene-based polymer may be the same or different in each layer.

In an embodiment, the flexible multilayer film includes a seal layer composed of an ethylene-based polymer, or a linear or substantially linear polymer, or a single-site catalyzed linear or substantially linear polymer of ethylene and an alpha-olefin monomer such as 1-butene, 1-hexene or 1-octene, having a heat seal initiation temperature (HSIT) from 65° C. to less than 125° C. Applicant discovered that the seal layer with an ethylene-based polymer with a HSIT from 65° C. to less than 125° C. advantageously enables the formation of secure seals and secure sealed edges around the complex perimeter of the flexible container. The ethylene-based polymer with HSIT from 65° C. to less than 125° C. is a robust sealant which also allows for better sealing to the rigid fitment which is prone to failure. The ethylene-based polymer with HSIT from 65° C. to 125° C. enables lower heat sealing pressure/temperature during container fabrication. Lower heat seal pressure/temperature results in lower stress at the fold points of the gusset, and lower stress at the union of the films in the top segment and in the bottom segment. This improves film integrity by reducing wrinkling during the container fabrication. Reducing stresses at the folds and seams improves the finished container mechanical performance. The low HSIT ethylene-based polymer seals at a temperature below what would cause the outer layer to be compromised.

In an embodiment, the flexible multilayer film is a coextruded and/or laminated five layer, or a coextruded (or laminated) seven layer film having at least one layer containing a material selected from LLDPE, OPET, OPP (oriented polypropylene), BOPP, and polyamide.

In an embodiment, the flexible multilayer film is a coextruded and/or laminated five layer, or a coextruded (or laminated) seven layer film having at least one layer containing OPET or OPP.

In an embodiment, the flexible multilayer film is a coextruded (or laminated) five layer, or a coextruded (or laminated) seven layer film having at least one layer containing polyamide.

In an embodiment, the flexible multilayer film is a seven-layer coextruded (or laminated) film with a seal layer composed of an ethylene-based polymer, or a linear or substantially linear polymer, or a single-site catalyzed linear or substantially linear polymer of ethylene and an alpha-olefin monomer such as 1-butene, 1-hexene or 1-octene, having a Tm from 90° C. to 106° C. The outer layer is a polyamide having a Tm from 170° C. to 270° C. The film has a ΔTm from 40° C. to 200° C. The film has an inner layer (first inner layer) composed of a second ethylene-based polymer, different than the ethylene-based polymer in the seal layer. The film has an inner layer (second inner layer) composed of a polyamide the same or different to the polyamide in the outer layer. The seven layer film has a thickness from 100 micrometers to 250 micrometers.

FIG. 6 shows an enlarged view of the bottom seal area 33 (Area 6) of FIG. 1 and the front panel 26a. The fold lines 60 and 62 of respective gusset panels 18, 20 are separated by a distance U that is from 0 mm, or greater than 0 mm, or 0.5 mm, or 1.0 mm, or 2.0 mm, or 3.0 mm, or 4.0 mm, or 5.0 mm to 12.0 mm, or greater than 60.0 mm (for larger containers, for example). In an embodiment, distance U is from greater than 0 mm to less than 6.0 mm. FIG. 6 shows line A (defined by inner edge 29a) intersecting line B (defined by inner edge 29b) at apex point 35a. BDISP 37a is on the distal inner seal arc 39a. Apex point 35a is separated from BDISP 37a by a distance S having a length from greater than 0 mm, or 1.0 mm, or 2.0 mm, or 2.6 mm, or 3.0 mm, or 3.5 mm, or 3.9 mm to 4.0 mm, or 4.5 mm, or 5.0 mm, or 5.2 mm, or 5.5 mm, or 6.0 mm, or 6.5 mm, or 7.0 mm, or 7.5 mm, or 7.9 mm.

In FIG. 6, an overseal 64 is formed where the four peripheral tapered seals 40a-40d converge in the bottom seal area 33. The overseal 64 includes 4-ply portions 66, where a portion of each panel is heat sealed to a portion of every other panel. Each panel represents 1-ply in the 4-ply heat seal. The overseal 64 also includes a 2-ply portion 68 where two panels (front panel 22 and rear panel 24) are sealed together. Consequently, the “overseal,” as used herein, is the area where the peripheral tapered seals 40a-40d converge that is subjected to a subsequent heat seal operation (and subjected to at least two heat seal operations altogether). The overseal 64 is located in the peripheral tapered seals 40a-40d and does not extend into the chamber of the flexible container 10.

In an embodiment, the apex point 35a is located above the overseal 64. The apex point 35a is separated from, and does not contact the overseal 64. The BDISP 37a is located above the overseal 64. The BDISP 37a is separated from and does not contact the overseal 64.

In an embodiment, the apex point 35a is located between the BDISP 37a and the overseal 64, wherein the overseal 64 does not contact the apex point 35a and the overseal 64 does not contact the BDISP 37a.

The distance between the apex point 35a to the top edge of the overseal 64 is defined as distance W, shown in FIG. 6. In an embodiment, the distance W has a length from 0 mm, or greater than 0 mm, or 2.0 mm, or 4.0 mm to 6.0 mm, or 8.0 mm, or 10.0 mm or 15.0 mm.

When more than four webs are used to produce the container, the portion 68 of the overseal 64 may be a 4-ply, or a 6-ply, or an 8-ply portion.

In an embodiment, the flexible container 10 has a vertical drop test pass rate from 90%, or 95% to 100%. The vertical drop test is conducted as follows. The container is filled with tap water to its nominal capacity, conditioned at 25° C. for at least 3 hours, held in upright position from its top handle 12 at 1.5 m height (from the base or side of the container to the ground), and released to a free fall drop onto a concrete slab floor. If any leak is detected immediately after the drop, the test is recorded as a failure. A minimum of twenty flexible containers are tested. A percentage for pass/fail containers is then calculated.

In an embodiment, the flexible container 10 has a side drop pass rate from 90%, or 95% to 100%. This side drop test is conducted as follows. The container is filled with tap water to its nominal capacity, conditioned at 25° C. for at least 3 hours, held in upright position from its top handle 12. The flexible container is released on its side from a 1.5 m height to a free fall drop onto a concrete slab floor. If any leak is detected immediately after the drop, the test is recorded as failure. A minimum of twenty flexible containers are tested. A percentage for pass/fail containers is then calculated.

In an embodiment, the flexible container 10 passes the stand-up test where the package is filled with water at ambient temperature and placed on a flat surface for seven days and it should remain in the same position, with unaltered shape or position.

In an embodiment, the flexible container 10 has a volume from 0.050 liters (L), or 0.1 L, or 0.15 L, or 0.2 L, or 0.25 L, or 0.5 L, or 0.75 L, or 1.0 L, or 1.5 L, or 2.5 L, or 3 L, or 3.5 L, or 4.0 L, or 4.5 L, or 5.0 L to 6.0 L, or 7.0 L, or 8.0 L, or 9.0 L, or 10.0 L, or 20 L, or 30 L.

The flexible container 10 can be used to store any number of flowable substances therein. In particular, a flowable food product can be stored within the flexible container 10. In one aspect, flowable food products such as salad dressings; sauces; dairy products; mayonnaise; mustard; ketchup; other condiments; syrup; beverages such as water, juice, milk, carbonated beverages, beer, or wine; animal feed; pet feed; and the like can be stored inside of the flexible container 10.

The flexible container 10 is suitable for storage of other flowable substances including, but not limited to, oil, paint, grease, chemicals, suspensions of solids in liquid, and solid particulate matter (powders, grains, granular solids).

The flexible container 10 is suitable for storage of flowable substances with higher viscosity and requiring application of a squeezing force to the container in order to discharge. Nonlimiting examples of such squeezable and flowable substances include grease, butter, margarine, soap, shampoo, animal feed, sauces, and baby food.

2. Fitment

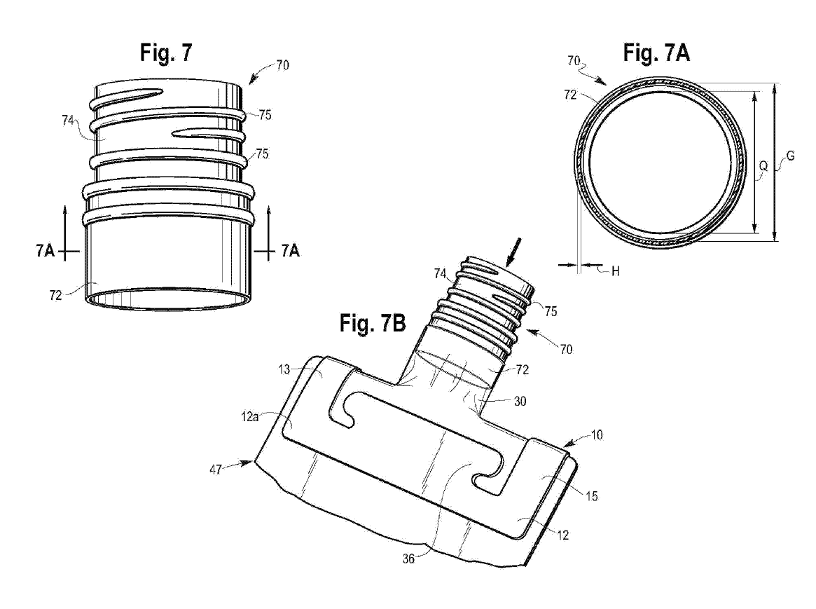

The present process includes positioning, or otherwise inserting, a fitment 70 into the neck 30 of the flexible container 10. The fitment 70 includes a base 72 and a top portion 74, as shown in FIG. 7. The fitment 70 is composed of one or more polymeric materials. The base 72 and the top portion 74 may be made from the same polymeric material or from different polymeric materials. In an embodiment, the base 72 and the top portion 74 are made from the same polymeric material.

The top portion 74 may include threads 75 or other suitable structure for attachment to a closure. Nonlimiting examples of suitable fitments and closures, include, screw cap, flip-top cap, snap cap, liquid or beverage dispensing fitments (stop-cock or thumb plunger), Colder fitment connector, tamper evident pour spout, vertical twist cap, horizontal twist cap, aseptic cap, vitop press, press tap, push on tap, lever cap, conro fitment connector, and other types of removable (and optionally reclosable) closures. The closure and/or fitment 70 may or may not include an expandable collar. In an embodiment, the closure is watertight. In a further embodiment, the closure provides a hermetic seal to the container 10.

The base 72 has a cross sectional shape. The cross sectional shape of the base 72 is selected from ellipse, circle, and regular polygon.

In an embodiment, the cross-sectional shape of the base 72 is an ellipse. An “ellipse,” as used herein, is a plane curve such that the sums of the distances of each point in its periphery from two fixed points, the foci, are equal. The ellipse has a center which is the midpoint of the line segment linking the two foci. The ellipse has a major axis (the longest diameter through the center). The minor axis is the shortest line through the center. The ellipse center is the intersection of the major axis and the minor axis. As used herein, the diameter (d) for the ellipse is the major axis.

In an embodiment, the cross-sectional shape is slightly elliptical, where the ratio of major axis to minor axis is between 1.01 to 1.25.

In an embodiment, the cross-sectional shape for the base 72 is a circle (or is substantially a circle). A “circle,” as used herein, is a closed plane curve consisting of all points at a given distance from a point within it called the center. The radius (r) for the circle is the distance from the center of the circle to any point on the circle. The diameter (d) for the circle is 2r.

In an embodiment, the cross sectional shape for the base is a regular polygon. A “polygon,” as used herein, is a closed plane figure, having three or more straight sides. The point where two sides meet is a “vertex.” A “regular polygon,” as used herein, is a polygon that is equiangular (all angles are equal in measure) and equilateral (all sides have the same length). The radius (r) for a regular polygon is defined by Formula (1) below.

$$radius = \frac{s}{2 sin ( \frac{π}{n} )} \qquad Formula ( 1 )$$

wherein

s is the length of any side;

n is the number of sides; and

sin is the sine function.

The diameter (d) for a regular polygon is 2(r) wherein the radius, r, for the regular polygon is determined by way of Formula (1). Nonlimiting examples of suitable regular polygon shapes for the cross-section of the base 72 include equilateral triangular, regular square, regular pentagon, regular hexagon, regular heptagon, regular octagon, regular nonagon, regular decagon, regular hendecagon, or regular dodecagon shape.

The cross-sectional shape of the top portion 74 may be the same or different than the cross-sectional shape of the base 72.

The cross-sectional shape of the base 72 may be circular, slightly elliptical, or regular polygonal. In an embodiment, the cross-sectional shape of the base 72 is circular, or substantially circular, as shown in FIGS. 7, 7A, 7B, 10A-10F, and 14.

The base 72 with a circular or regular polygon cross-sectional shape is distinct from fitments with a canoe-shaped fitment base or fitments with a base having opposing radial fins. In an embodiment, the fitment 70 excludes fitments that include a canoe-shaped base, fitments with a base that has radial fins, fitments with a wing-shaped base, and fitments with an eye-shaped base.

The outer surface of the base 72 may or may not include surface texture. In an embodiment, the outer surface of the base 72 has surface texture. Nonlimiting examples of surface texture include embossment, and a plurality of radial ridges to promote sealing to the inner surface of the neck wall 50.

In an embodiment, the outer surface of base 72 is smooth and does not include surface texture, as shown in FIG. 7.

In an embodiment, the diameter of the base 72 is greater than the diameter of the top portion 74. FIG. 7A shows the diameter of base G having a length that is greater than the length of the diameter Q, the diameter of the top portion 74. The fitment 70 with a base diameter G that is greater than top portion diameter Q advantageously promotes unimpeded pouring of content from the flexible container 10.

The fitment 70 is made from a polymeric material. Nonlimiting examples of suitable polymeric materials include propylene-based polymer, ethylene-based polymer, polyamides (such as Nylon 6; Nylon 6,6; Nylon 6,66; Nylon 6,12; Nylon 12 and the like), cyclic olefin copolymers (COC)(such as TOPAS™ or APEL™), polyesters (crystalline and amorphous), copolyester resin (such as PETG), cellulose esters (such as polylactic acid (PLA)), and combinations thereof.

3. Mandrel

The process includes inserting a mandrel 80 into the fitment 70. The mandrel 80 can be inserted into the fitment 70 before the fitment 70 is positioned into the neck 30, or after the fitment 70 is positioned into the neck 30.

In an embodiment, the fitment 70 is positioned in the neck 30 of the flexible container 10 before the mandrel 80 is inserted into the fitment as shown in FIG. 7B.

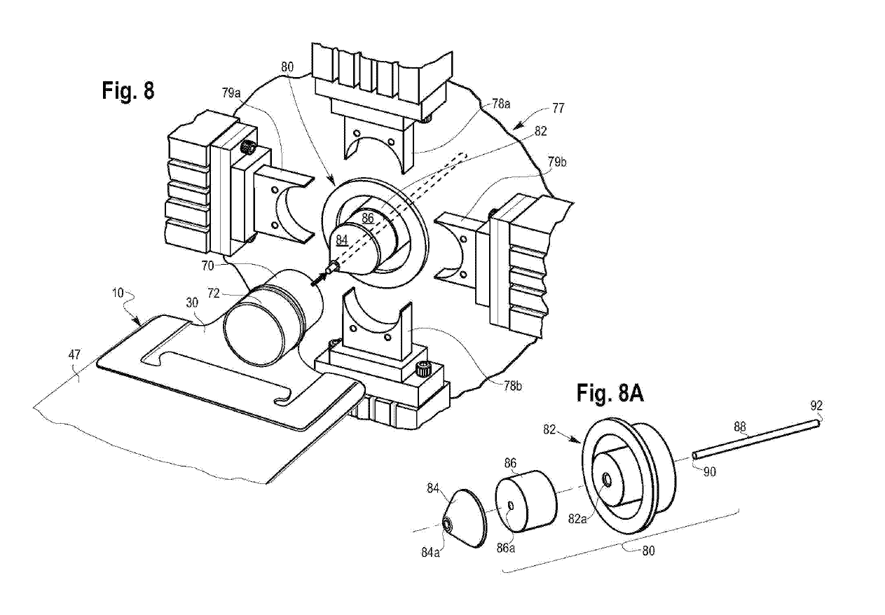

In an embodiment, a heat seal apparatus 77 includes a first pair of opposing seal bars 78a, 78b, a second pair of opposing seal bars 79a, 79b and a mandrel 80, as shown in FIG. 8. The fitment 70 is aligned with the mandrel 80 and the flexible container 10 (with fitment 70) is moved toward the heat seal apparatus 77 so that the mandrel 80 inserts into, or otherwise enters, the fitment 70 in a male-female engagement.

The mandrel 80 includes a mandrel base 82, a nosecone 84, and an expandable collar 86, as shown in FIG. 8A. The expandable collar 86 is disposed, or otherwise is sandwiched, between the mandrel base 82 and the nosecone 84. The mandrel base 82, the nosecone 84, and the expandable collar 86 each has a respective channel 82a, 84a, and 86a, as best seen in the exploded view of FIG. 8A. The channels 82a, 84a, and 86a are aligned and a pull bar 88 extends through channels 82a, 84a, and 86a. A distal end 90 of the pull bar 88 is attached to the nosecone 84. A proximate end 92 of the pull bar 88 is in operative communication with a motor (not shown), or other suitable mechanism, for extension and retraction of the pull bar 88 through the channels 82a, 84a, and 86a. The pull bar 88 can be permanently attached or releasably attached to the nosecone 84. Although FIG. 8A shows nosecone 84 with a frustoconical shape, the nosecone 84 may have other shapes, including but not limited to cylindrical.

A “collar,” as used herein, is a structure that is cylindrical, or substantially cylindrical, in shape. The expandable collar 86 is composed of an elastomeric material. An “elastomeric material,” as used herein, is a material that can be stretched with the application of stress to at least twice its length and, after release of the stress, returns to its approximate original dimensions and shape. The elastomeric material may, or may not, be a vulcanized material. Nonlimiting examples of suitable elastomeric material include ethylene propylene diene monomer terpolymer (EPDM), ethylene propylene (EPM), hydrogenated nitrile butadiene rubber (HNBR), polyacrylic rubber, silicone rubber, fluorosilicone rubber, fluoroelastomers, perfluoro rubber, and any combination of the foregoing.

As configured in the mandrel 80, the expandable collar 86 has an outer surface adapted to contact and support the inner surface of the fitment base 72. The stretch-ability of the elastomeric material from which the expandable collar 86 is made provides the collar 86 with the feature of expandability. The term “collar” and the term “expandable collar” may be used interchangeably.

In an embodiment, the expandable collar 86 is composed of, or is otherwise made from, a silicon rubber.

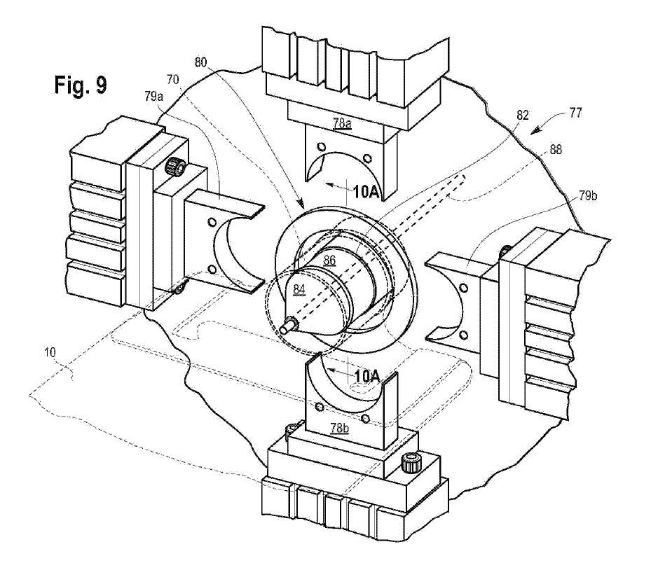

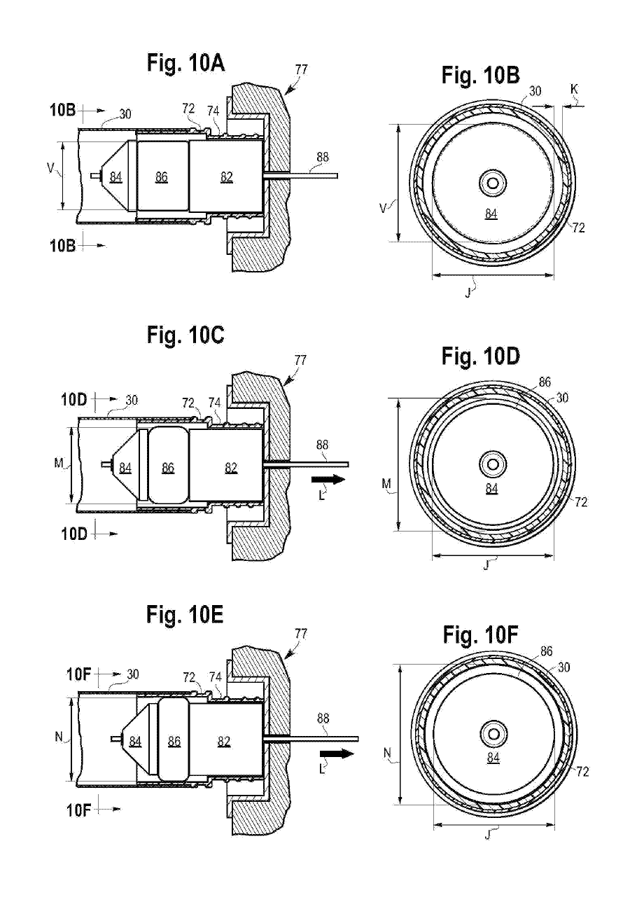

FIG. 9 shows the flexible container 10 mounted on the heat seal apparatus 77, whereby the mandrel 80 is inserted into the fitment 70. The flexible container 10 is shown in phantom lines to show the interaction between the mandrel 80 and the fitment 70 during the sealing procedure. Insertion of the mandrel 80 into the fitment 70 occurs when the pull bar 88 is extended and the expandable collar 86 is in a relaxed position. For the expandable collar 86, a “relaxed position,” is when the expandable collar 86 is not compressed by the mandrel base 82 and nosecone 84. In the relaxed position, the expandable collar 86 has a diameter V that is less than or equal to the diameter J of the nosecone 84, as shown in FIGS. 10A and 10B. Diameter V is less than the inner diameter of the fitment 70.

The mandrel 80 may engage the fitment 70 by way of friction fit. Alternatively, a gap K is present between the outer surface of the fitment 70 and the mandrel 80, as shown in FIG. 10B. The gap K may be continuous or discontinuous around the circumference of the mandrel 80. The gap K may or may not extend around the entire circumference of the mandrel 80. In other words, partial contact may occur between the fitment 70 and the mandrel 80 with gap K still being present.

After the mandrel 80 is inserted into the fitment 70, the pull bar 88 is retracted (shown by Arrow L in FIG. 10C), compressing the expandable collar 86 between the mandrel base 82 and the nosecone 84. The expandable collar 86 is squeezed between the mandrel base 82 and the nosecone 84, the squeezing force expanding the collar 86 radially outward, as shown in FIGS. 10C and 10D. The partially radially expanded collar 86 has a diameter M that is greater than the nosecone diameter J, as shown in FIGS. 10C and 10D.

Further retraction of the pull bar 88 (Arrow L in FIG. 10E) imparts additional compressive force upon the expandable collar 86, further squeezing the collar 86 and fully expanding the collar 86 radially outward. The fully radially expanded collar 86 has a diameter N that is greater than the nosecone diameter J. Radially expanded collar 86 with diameter N fully contacts the inner surface of the base 72 and fully supports the base 72. The diameter N of the fully radially expanded collar 86 is greater than the diameter M of the partially radially expanded collar 86, which is greater than the diameter V of the expandable collar 86 in a relaxed position.

In an embodiment, the process includes retracting the pull bar 88 and radially expanding the collar 86 to produce a radially expanded collar with a radially expanded diameter from 1%, or 5%, or 10%, or 15%, or 20%, or 25%, or 30%, or 40%, or 50% to 60%, or 70%, or 75%, or 80%, or 90%, or 100% to 125%, or 150%, or 175%, or 200% greater than the diameter of the expandable collar 86 in the relaxed position. In other words, the length of the diameter for the expanded collar 86 (diameter M or diameter N) is from 1% to 200% greater than the length of diameter V, the diameter of the collar 86 in the relaxed state.

4. Seal Bars

Once the expandable collar 86 is radially expanded, the process includes sealing, with a pair of opposing seal bars, the fitment 70 to the neck 30.

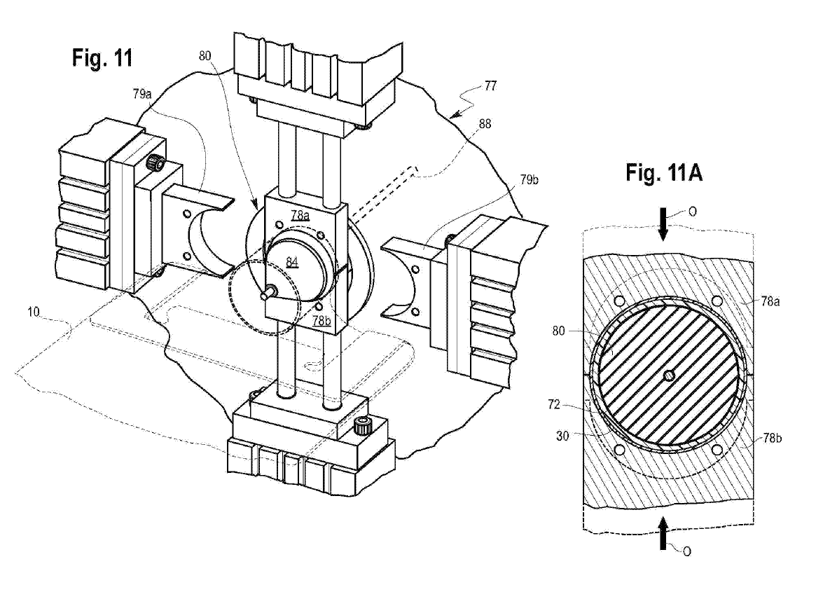

In an embodiment, the process includes first sealing, with a first pair of opposing seal bars in a first orientation, the fitment 70 to the neck 30. The first orientation for the opposing seal bars can be a vertical orientation or a horizontal orientation. FIG. 11 shows the first pair of opposing seal bars 78a, 78b, in a vertical orientation. The first pair of opposing seal bars 78a, 78b engage and contact the neck 30 and the base 72, as shown in FIGS. 11 and 11A. The opposing seal bars are heated to a temperature greater than or equal to the melt temperature (Tm) of the seal layer of the multilayer film of the neck 30 and less than the melt temperature of the fitment 70. The opposing seal bars 78a, 78b compress the seal layer of the multilayer film against the outer surface of the base 72 for a duration from 0.1 seconds, or 0.5 seconds, or 1.0 second, or 2.0 seconds, or 3.0 seconds, or 4.0 seconds to 5.0 seconds, or 6.0 seconds, or 7.0 seconds, or 8.0 seconds, or 9.0 seconds, or 10 seconds. The radially expanded collar 86 supports the base 72 during the contact and compression between the opposing seal bars 78a, 78b and the neck 30. The opposing seal bars 78a, 78b impart heat and pressure onto the multilayer film of the neck 30 and the base 72 to weld, or otherwise heat seal, the neck 30 to the base 72. The inward pressure of the seal bars 78a, 78b, shown by Arrows O (FIG. 11A), is offset with an equal and opposite counterforce and outward pressure from the radially expanded collar 86.

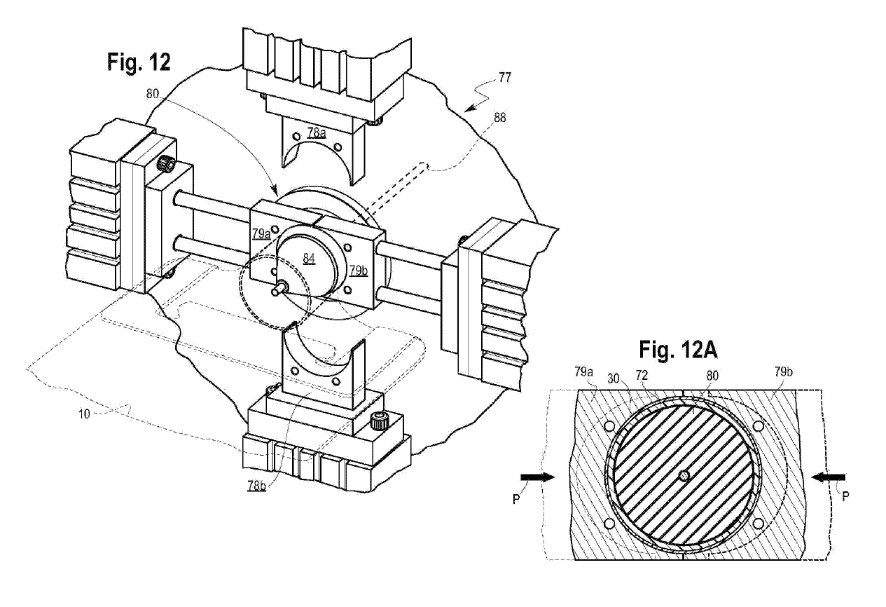

In an embodiment, the process includes second sealing, with a second pair of opposing seal bars in a second orientation, the fitment 70 to the neck 30. The second orientation for the opposing seal bars can be a vertical orientation or a horizontal orientation. The second pair of opposing seal bars are offset 90° from the orientation of the first pair of opposing seal bars. FIG. 12 shows the second pair of opposing seal bars 79a, 79b, in a horizontal orientation. The second pair of opposing seal bars 79a, 79b engage and contact the neck 30 and the base 72. The heat seal conditions for the second pair of opposing seal bars can be the same or different than the heat seal conditions for the first pair of opposing seal bars discussed above. The opposing seal bars 79a, 79b impart heat and pressure onto the multilayer film of the neck 30 and the base 72 to weld, or otherwise heat seal, the neck 30 to the base 72. The inward pressure of the seal bars 79a, 79b shown by Arrows P (FIG. 12A) is offset with an equal and opposite counterforce and outward pressure from the radially expanded collar 86. The radially expanded expandable collar 86 advantageously supports the fitment base 72 during sealing.

During the first seal step and the second seal step, the extent of radial expansion for the expandable collar 86 may vary. Nonlimiting examples of conditions that may influence the extent of radial expansion for the expandable collar 86 include (i) heat seal pressure, (ii) heat seal duration, (iii) fitment 70 composition, (iv) base 72 diameter, (v) base 72 wall thickness, and (vi) any combination of (i) through (v). Hence, the degree of compression (squeeze) upon the expandable collar 86 can be varied, or otherwise tailored, so the radial expansion of the expandable collar 86 provides a counter force to match the seal bar pressure. In other words, the extent of radial expansion for the expandable collar 86 (and resultant support force) can be adjusted based on sealing pressure and/or the properties of the fitment 70. Regardless of the extent of expansion, the radially expanded collar 86 advantageously provides a continuous and uniform support surface in contact with the inner surface of the base 72 during heat seal process.

The seal conditions for the first sealing step and the second sealing step may be the same or different. For each sealing step, the heat seal bar pressure between the fitment 70 and the seal bars is from 0.25 bar, or 0.4 bar, or 0.5 bar, or 0.75 bar, or 1.0 bar to 3 bar, or 4 bar, or 6 bar, or 8 bar. The expandable collar 86 is adjustable to provide sufficient support to the fitment 70, allowing the seal pressure to be imparted without distortion of the fitment 70. The seal widths can be from 2 mm, or 4 mm, or 6 mm, or 8 mm, or 10 mm, or 12 mm to 14 mm, or 16 mm, or 18 mm, or 21 mm, or 23 mm, or 25 mm. The seal bars can be made to match the desired seal width.

In an embodiment, the width of the radially expanded collar 86 is equal to or greater than the width of the opposing seal bars.

In an embodiment, the heat seal conditions of the first seal step are the same as the heat seal conditions for the second seal step. The pressure for the second pair of opposing seal bars and the widths of seals are the same as the pressure for the first pair of opposing seal bars.

The two step seal process ensures formation of a weld, or the formation of a heat seal, around the entire outer circumference of the base 72. In an embodiment, the process includes forming a hermetic seal between the neck 30 and the base 72.

In an embodiment, the process includes supporting, during the sealing, the fitment base 72 with the radially expanded collar 86 and preventing deformation of the fitment 70 during the sealing procedure. In a further embodiment, the process includes aligning the opposing seal bars with the radially expanded collar 86. The opposing seal bars contact the neck 30 and fitment base 72 outer surface at the area under which the radially expanded collar 86 contacts and supports the base 72 inner surface. In this way, the contact point between the opposing seal bars and the base 72 outer surface is directly aligned. The fitment 70 undergoes no, or substantially no, deformation during the sealing procedure.

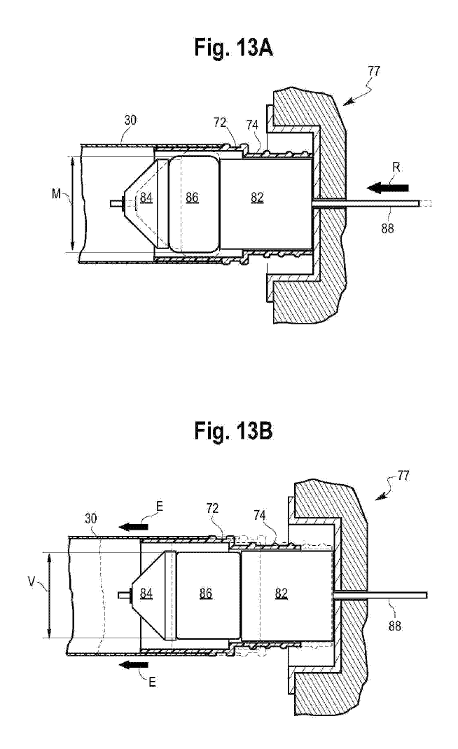

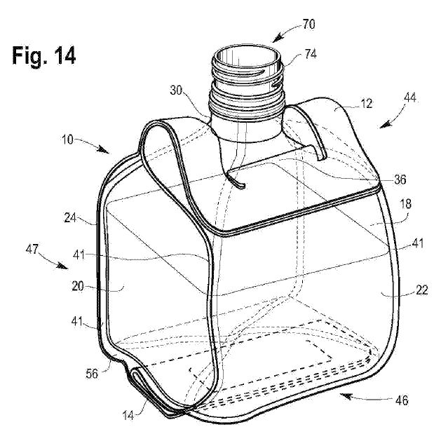

Upon completion of the sealing procedure, the pull bar 88 is extended (shown by Arrow R in FIG. 13A) and the radially expanded collar 86 returns to the relaxed position, as shown in FIGS. 13A and 13B. In the relaxed position, the expandable collar 86 has relaxed diameter V. With the expandable collar 86 in the relaxed position, the flexible container 10 with the installed fitment 70 is removed from the sealing apparatus 77 (shown by Arrows E in FIG. 13B). The flexible container 10 with fitment 70 welded at neck 30 is shown in FIG. 14.

In an embodiment, the base 72 has a diameter (d) and a wall thickness (WT) as shown in FIG. 7A. In FIG. 7A, the base 72 diameter (d) is shown as distance G and the wall thickness (WT) is shown as the distance H. The base 72 diameter (d) can be uniform or can vary along the length of the base 72. Similarly, the wall thickness (WT) can be uniform or can vary along the length of the base 72.

In an embodiment, the diameter of the base 72 is uniform along the base length and the wall thickness (WT) is uniform along the base length.

In an embodiment, the base 72 has a diameter (d) from 5 mm, or 10 mm or 20 mm, or 25 mm, or 30 mm, or 35 mm, or 38 mm, or 40 mm, or 45 mm, or 47 mm, or 50 mm, or 60 mm, or 70 mm, or 80 mm, or 90 mm to 100 mm, or 110 mm, or 125 mm, or 150 mm, or 175 mm, or 200 mm.

In an embodiment, the base 72 has a wall thickness (WT) from 0.15 mm, or 0.2 mm, or 0.3 mm, or 0.4 mm, or 0.5 mm, or 0.6 mm, or 0.7 mm, or 0.75 mm, or 0.8 mm, or 0.9 mm, or 1.0 mm to 1.3 mm, or 1.5 mm, or 1.7 mm, or 1.9 mm, or 2.0 mm.

In an embodiment, the base 72 has a wall thickness (WT) from 0.15 mm, or 0.2 mm, or 0.3 mm, or 0.4 mm to 0.5 mm, or 0.6 mm, or 0.7 mm, or 0.75 mm. As used herein, a base wall thickness (WT) with the foregoing wall thickness from 0.15 mm to 0.75 mm is a “thin-wall.”

The base 72 has a diameter to wall thickness ratio. The “diameter to wall thickness ratio” (denoted as “d/WT”) is the diameter (d) of the base 72 (in millimeters, mm) divided by the wall thickness (WT), in mm, of the base 72. In an embodiment, the base 72 has a d/WT from 5, or 8, or 10, or 20, or 30, or 40, or 50, or 60, or 70, or 80, or 90, or 100, or 125, or 150, or 175, or 200 to 500, or 525, or 550, or 575, or 600, or 625, or 650, or 675, or 700, or 725, or 750, or 775, or 800, or 825, or 850, or 875, or 900, or 925, or 950, or 975, or 1000, or 1100, or 1200, or 1300, or 1400, or 1500, or 1600, or 1700, or 1800, or 1900, or 2000.

In an embodiment, the base 72 has a d/WT from 35, or 40, or 50, or 60, or 70, or 80, or 90, or 100, or 125, or 150, or 175 to 200, or 225, or 250, or 275, or 300, or 325, or 350, or 375, or 400, or 425, or 450, or 475, or 500, or 525, or 550 or 600, or 650, or 700, or 750, or 800.

In an embodiment, the base 72 has a d/WT ratio from 35 to 800, the diameter (d) is from 10 mm, or 20 mm, or 30 mm, or 35 mm, or 38 mm, or 40 mm, or 45 mm, or 47 mm, or 50 mm to 60 mm, or 70 mm, or 80 mm, or 90 mm, or 100 mm, or 110 mm, or 120 mm; and the wall thickness (WT) is from 0.15 mm, or 0.2 mm, or 0.3 mm, or 0.4 mm to 0.5 mm, or 0.6 mm, or 0.7 mm, or 0.75 mm. Thus, the base 72 has a thin-wall structure.

In an embodiment, the base 72 has a d/WT ratio from 35 to 800 as disclosed above. The diameter (d) for the base 72 is from 47 mm to 120 mm. The wall thickness (WT) for the base 72 is from 0.15 mm to 0.75 mm. Thus, the base 72 has a thin-wall structure.

In an embodiment, the base 72 has a d/WT ratio from 50 to 550 as disclosed above. The diameter (d) for the base 72 is from 10 mm to 110 mm. The wall thickness (WT) for the base 72 is from 0.2 mm to 0.5 mm. Thus, the base 72 has a thin-wall structure.

The fitment with a d/WT from 35 to 800 can include a base with a thin-wall structure. Thin-wall fitments advantageously reduce production costs, reduce material cost, and reduce the weight of the final flexible container 10.

In an embodiment, the present process produces a flexible container as described in copending application U.S. Ser. No. 62/146,021, filed on 10 Apr. 2015, the entire content of which is incorporated by reference herein.

The present process advantageously (i) expands the types of materials that can be used to make the fitment 70, (ii) enables the utilization of thin-wall fitments in flexible containers 10, and (iii) a combination of (i) and (ii). Bound by no particular theory, the ability of the mandrel 80 to prevent deformation of the fitment/base during sealing, advantageously opens the door to new possibilities in flexible packaging. Polymeric materials prone to cracking or deformation when subjected to conventional fitment seal procedures can now be used in flexible packaging vis-a-vis the present process. The present process also enables the use of thin-wall fitments in flexible packaging. Thin-wall fitments advantageously reduce production costs, reduce material cost, and reduce the weight of the final flexible container.

The present process may comprise two or more embodiments disclosed herein.

### DEFINITIONS

The numerical ranges disclosed herein include all values from, and including, the lower value and the upper value. For ranges containing explicit values (e.g., 1, or 2, or 3 to 5, or 6, or 7) any subrange between any two explicit values is included (e.g., 1 to 2; 2 to 6; 5 to 7; 3 to 7; 5 to 6; etc.).

Unless stated to the contrary, implicit from the context, or customary in the art, all parts and percents are based on weight, and all test methods are current as of the filing date of this disclosure.

Clarity is measured in accordance with ASTM-D1746.

The term “composition,” as used herein, refers to a mixture of materials which comprise the composition, as well as reaction products and decomposition products formed from the materials of the composition.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

Density is measured in accordance with ASTM D 792.

An “ethylene-based polymer,” as used herein is a polymer that contains more than 50 mole percent polymerized ethylene monomer (based on the total amount of polymerizable monomers) and, optionally, may contain at least one comonomer.

Haze is measured in accordance with ASTM D1003 (method B) and noting the thickness of the part.

The term “heat seal initiation temperature,” is minimum sealing temperature required to form a seal of significant strength, in this case, 2 lb/in (8.8N/25.4 mm). The seal is performed in a Topwave HT tester with 0.5 seconds dwell time at 2.7 bar (40 psi) seal bar pressure. The sealed specimen is tested in an Instron Tensiomer at 10 in/min (4.2 mm/sec or 250 mm/min).

Melt flow rate (MFR) is measured in accordance with ASTM D 1238, Condition 280° C./2.16 kg (g/10 minutes).

Melt index (MI) is measured in accordance with ASTM D 1238, Condition 190° C./2.16 kg (g/10 minutes).

Tm or “melting point” as used herein (also referred to as a melting peak in reference to the shape of the plotted DSC curve) is typically measured by the DSC (Differential Scanning calorimetry) technique for measuring the melting points or peaks of polyolefins, as described in U.S. Pat. No. 5,783,638. It should be noted that many blends comprising two or more polyolefins will have more than one melting point or peak, many individual polyolefins will comprise only one melting point or peak.

An “olefin-based polymer,” as used herein is a polymer that contains more than 50 mole percent polymerized olefin monomer (based on total amount of polymerizable monomers), and optionally, may contain at least one comonomer. Nonlimiting examples of olefin-based polymer include ethylene-based polymer and propylene-based polymer.

A “polymer” is a compound prepared by polymerizing monomers, whether of the same or a different type, that in polymerized form provide the multiple and/or repeating “units” or “mer units” that make up a polymer. The generic term polymer thus embraces the term homopolymer, usually employed to refer to polymers prepared from only one type of monomer, and the term copolymer, usually employed to refer to polymers prepared from at least two types of monomers. It also embraces all forms of copolymer, e.g., random, block, etc. The terms “ethylene/α-olefin polymer” and “propylene/α-olefin polymer” are indicative of copolymer as described above prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to has being based on “units” that are the polymerized form of a corresponding monomer.

A “propylene-based polymer” is a polymer that contains more than 50 mole percent polymerized propylene monomer (based on the total amount of polymerizable monomers) and, optionally, may contain at least one comonomer.

Some embodiments of the present disclosure will now be described in detail in the following Examples.

### EXAMPLES

### 1. Production of Flexible Container (no fitment)

Four panel flexible containers having a neck and a body as shown in FIGS. 1-6 are formed using the seven-layer film provided in Table 1. Each of the four panels is made with the seven-layer film shown in Table 1. The four-panel flexible containers are produced with a volume of either 3.875 L or 20 L and are produced by ISO Poly Films (Gray Court, S.C.). The 3.875 L flexible containers use a 150 micrometer (μm) film and the 20 L containers use both 150 μm and 250 μm film.

TABLE 1
Composition of flexible multilayer film for flexible container panels
(7 layer co-extruded flexible multilayer film)

| Overall | Description | % Thickness | Weight % | Layer | Density |
|---|---|---|---|---|---|
| ULTRAMID C33L01 | Nylon 6/66 viscosity number 195 cm³/g (ISO | 13.0% | 15.3% | 1 | 1.12 |
| | 307 @ 0.5% in 96% H₂SO₄), melting point | | | | |
| | 196° C. (ISO 3146) | | | | |
| AMPLIFY TY1352 | Maleic anhydride grafted polyethylene 0.922 | 12.0% | 11.6% | 2 | 0.922 |
| | g/cm³; 1.0 Ml @ 2.16 Kg 190° C., melting point | | | | |
| | 125° C. | | | | |
| ELITE 5400G | Polyethylene density 0.916 g/cm³; | 20.0% | 19.2% | 3 | 0.916 |
| | 1.0 Ml @ 2.16 Kg 190° C., melting point 123° C. | | | | |
| AMPLIFY TY1352 | Maleic anhydride grafted polyethylene 0.922 | 12.0% | 11.6% | 4 | 0.922 |
| | g/cm³; 1.0 Ml @ 2.16 Kg 190° C., melting point | | | | |
| | 125° C. | | | | |
| ULTRAMID C33L01 | Nylon 6/66 viscosity number 195 cm³/g (ISO | 6.0% | 7.0% | 5 | 1.12 |
| | 307 @ 0.5% in 96% H₂SO₄), melting point | | | | |
| | 196° C. (ISO 3146) | | | | |
| AMPLIFY TY1352 | Maleic anhydride grafted polyethylene 0.922 | 12.0% | 11.6% | 6 | 0.922 |
| | g/cm³; 1.0 Ml @ 2.16 Kg 190° C., melting point | | | | |
| | 125° C. | | | | |
| AFFINITY PF1146G | Ethylene alpha-olefin copolymer 0.899 g/cm³; | 23.6% | 22.3% | 7* | 0.899 |
| | 1.0 Ml @ 2.16 Kg 190° C., melting point 95° C. | | | | |
| AMPACET 10090 | Slip masterbatch available from Ampacet | 1.0% | 1.0% | 7* | 0.92 |
| (S) | Corp. containing LDPE | | | | |
| AMPACET 10063 | Antiblock masterbatch available from | 0.4% | 0.4% | 7* | 1.05 |
| (AB) | Ampacet Corp. containing polyethylene | | | | |
| Total | | 100.0% | 100.0% | | |

*layer 7 is a 3-component blend, layer 7 is the heat seal layer (or seal layer)

Four panels made from the flexible multilayer film in Table 1 are heat sealed together under the heat seal conditions provided in Table 2 (below) to produce flexible containers. The flexible containers are fabricated by KRW Machinery Inc (Weaverville, N.C.). All heat seals in the flexible containers are made with one strike.

Tables 2A-2B. Heat Seal Conditions for multilayer films
Table 2A. Web Sandwich of 0.6 mm, 4-ply, 150 μm panels

| | Seal Bar | Platen | Dwell | | |
|---|---|---|---|---|---|
| | Temperature, | Pressure, | Time, | Overseal protrusion | |
| Seals | ° C. | J/cm² | sec | height, mm | Seal Bar Dimensions |
| Peripheral | 143 | 258 | 0.75 | 0 | 10 mm × perimeter for 3.875 L |
| | | | | | 15 mm × perimeter for 20 L |
| Overseal | 182 | 258 | 0.75 | 0.30 | 3.2 mm × 25.4 mm (overseal |
| | | | | | bar, centered about the apex |
| | | | | | point, W = 3.5 mm) |

Table 2B. Web Sandwich of 1.0 mm, 4-ply, 250 μm panels

| | Seal Bar | Platen | Dwell | | |
|---|---|---|---|---|---|
| | Temperature, | Pressure, | Time, | Overseal protrusion | |
| Seals | ° C. | bar | sec | height, mm | Seal Bar Dimensions |
| Peripheral | 174 | 7.4 | 3.6 | 0 | 10 mm × perimeter for 3.875 L |
| | | | | | 15 mm × perimeter for 20 L |
| Overseal | 185 | 7.4 | 3.6 | 0.5 | 3.2 mm × 25.4 mm (overseal |
| | | | | | bar, centered about the apex |
| | | | | | point, W = 3.5 mm) |

### 2. Fitment Sealed to Neck Using Expandable Mandrel

Fitments with different base diameters and different base wall thicknesses are inserted into the neck for respective flexible containers. The fitments are made from the same high density polyethylene (HDPE). The dimensions and surface texture of the base for each fitment are provided in Table 3 below.

TABLE 3
Fitment properties

| | Base | Base Wall | | |
|---|---|---|---|---|
| | Diameter, | Thickness, | | Fitment outer |
| Fitment | (d) mm | (WT) mm | d/WT | surface texture |
| HDPE 1 | 41 | 1.6 | 25.6 | Ribbed |
| HDPE 2 | 41 | 0.75 | 54.7 | Ribbed |
| HDPE 3 | 110 | 1.27 | 86.7 | Smooth |
| HDPE 4 | 110 | 0.5 | 220 | Smooth |
| HDPE 5 | 110 | 0.2 | 550 | Smooth |
| INFUSE ™ 9817 | 41 | 1.6 | 25.6 | Ribbed |

The fitments are washed thoroughly in denatured alcohol and allowed to dry to prepare surfaces prior to heat sealing to the neck of the flexible container.

Two mandrels are used to heat seal fitments to the flexible containers. A 38 mm diameter mandrel is used for the 3.875 L flexible containers. A 110 mm diameter mandrel is used for the 20 L flexible containers. Each mandrel includes an expandable collar. Each expandable collar is made of Shore A 30+/−5 durometer FDA approved silicone rubber. Applicant discovered that silicone rubber is advantageous because of its heat stability, softness and durability.

Properties for the expandable collars are provided in Table 4 below.

TABLE 4
Exoandable Collar Prooerties

| | 38 mm mandrel for | 110 mm mandrel for |
|---|---|---|
| Expandable | 3.875 L flexible | 20 L flexible |
| Collar properties | container | container |
| Center hole diameter (mm) | 6.35 | 44.5 |
| Relaxed diameter (mm) | 29.4 | 97.1 |
| Radially expanded | 44.6 (at 150% | 118.3 (at 122% |
| diameter (mm) | expansion, 110 psi) | expansion, 75 psi) |

For the 3.875 L flexible containers, opposing seal bars each with a length of 41 mm are used. The seal width for each opposing seal bar is 10.2 mm. The seal bar area for each 41 mm seal bar is 0.0004907 m².

For the 20 L flexible containers, opposing seals bars each with a length of 110 mm are used. The seal width for each opposing seal bar is 15.2 mm. The seal bar area for each of the 110 mm seal bars is 0.00179 m².

The base of the fitment is heat sealed to the neck of the flexible container using a mandrel with an expandable collar as set forth herein. The heat seal conditions for the fitment seal are provided in Table 5 below. Table 5 also provides fitment seal integrity data—(i) burst test data and (ii) hang test data for the fitment seal. In Table 5, “E” denotes inventive example, “CE” denotes comparative sample, and “NS” denotes not sampled.

### 3. Tests

Burst Test Procedure

Process:
1.) All flexible containers are numbered/tagged with testing number, identifying film #, and production set points (if necessary).
2.) All flexible containers are pre-inflated via manual inflation or compressed air.
3.) Caps are applied tightly.
4.) Flexible containers are placed inside the vacuum pressure chamber and lid is closed.
5.) Vacuum pressure is applied via vacuum pump. Pressure should be applied slowly as flexible container continues to inflate.
6.) Units of vacuum are recorded in (inHg). Exceptional results are 18 (inHG) held for 60 seconds. Passing is 12 (inHg).
7.) Any weak areas of seal will be exposed as leaks during the testing time period. Bubbles should be looked for and can indicate a weak area of the flexible container.
8.) The flexible container is filled completely with air and the closure on the fitment is tightened. Then, the flexible container is completely submerged in a water bath. The chamber over the water is then evacuated to create a vacuum. A “pass” score for the burst test is when there are no bubbles visually observed in the water bath after 30 seconds at 40 kilopascals of vacuum.

Gravity Hang Test Procedure

Process:
1.) All flexible containers are numbered/tagged with testing number, identifying film #, and production set points (if necessary).
2.) All flexible containers are filled with room temp water to recommended fill height.
3.) 3 drops of Methylene Blue die and 3 drops of surfactant (soap) are added to each flexible container and agitated.
4.) Closures are applied tightly to the fitment.
5.) Flexible containers are then hung both neck side down and neck side up to test the strength of both the neck seal and the caulk seal areas.
6.) Flexible containers are left hanging for 48 hours.
7.) Any weak areas of seal will be exposed as leaks during the testing time period.
8.) A “pass” score for the hang test is hanging the flexible container for 48 hours without a leak detected. Leaks are detected by visual identification of white paper below the flexible container to show any drops that have fallen. The water solution added to the flexible container contains a blue vegetable dye for aiding visual detection of the leak. The water solution also contains a drop or two of soap (Dawn dish soap) where the soap surfactant helps allow water to penetrate any gaps in seal that might be present.

TABLE 5

| | | | | | | | | | | | Perm- | | |
|---|---|---|---|---|---|---|---|---|---|---|---|---|---|
| | | | | | | | | | | | anent | | |
| | | | | | | | | | | | deform- | | |
| | | Base | Wall | | | | | | | Expand- | ation | | |
| | | Dia- | Thick- | | | Film | Seal | Seal | | able | of | | |
| | | meter, | ness, | | Fitment | thick- | Temper- | pres- | Seal | Collar, | fitment | | |
| | | (d) | (WT) | | outer | ness, | ature, | sure, | time, | Expan- | during | Burst | Hang |
| Example | Fitment | mm | mm | d/WT | surface | μm | ° C. | bar | sec | sion | sealing | Test | Test |
| CE1 | HDPE1 | 41 | 1.65 | 24.8 | Ribbed | 150 | 177 | 2 | 5.5 | 0% | No | Fail | — |
| | | | | | | | 177 | 2 | 6 | 0% | No | Pass | Pass |
| | | | | | | | 177 | 2.2 | NS | 0% | Yes | — | — |
| | | | | | | | 177 | 4.9 | NS | 0% | Yes | — | — |
| | HDPE1 | 41 | 1.65 | 24.8 | Ribbed | 150 | 177 | 4.9 | 2 | 150% | No | Fail | — |
| E1 | HDPE1 | 41 | 1.65 | 24.8 | Ribbed | 150 | 177 | 4.9 | 2.5 | 150% | No | Pass | Pass |
| CE2 | HDPE2 | 41 | 0.75 | 54.7 | Ribbed | 150 | 177 | 2 | 5 | 0% | No | Fail | — |
| | | | | | | | 177 | 2 | 6 | 0% | Yes | — | — |
| | | | | | | | 177 | 2.2 | NS | 0% | Yes | — | — |
| | | | | | | | 177 | 4.9 | NS | 0% | Yes | — | — |
| | HDPE2 | 41 | 0.75 | 54.7 | Ribbed | 150 | 177 | 4.9 | 2 | 150% | No | Fail | — |
| E2 | HDPE2 | 41 | 0.75 | 54.7 | Ribbed | 150 | 177 | 4.9 | 2.5 | 150% | No | Pass | Pass |
| CE3 | HDPE3 | 110 | 1.27 | 86.7 | Smooth | 250 | 177 | 1.3 | 10 | 0% | No | Pass | Fail |
| | | | | | | | 177 | 1.3 | 20 | 0% | No | Pass | Pass |
| E3 | HDPE3 | 110 | 1.27 | 86.7 | Smooth | 250 | 177 | 1.3 | 7 | 116% | No | Pass | Pass |
| CE4 | HDPE4 | 110 | 0.5 | 220 | Smooth | 250 | 149 | 1.3 | NS | 0% | No | Fail | — |
| E4 | HDPE4 | 110 | 0.5 | 220 | Smooth | 250 | 149 | 1.3 | 10 | 116% | No | Pass | Pass |
| CE5 | HDPE4 | 110 | 0.5 | 220 | Smooth | 150 | 149 | 1.3 | NS | 0% | No | Fail | — |
| E5 | HDPE4 | 110 | 0.5 | 220 | Smooth | 150 | 149 | 1.3 | 6 | 116% | No | Pass | Pass |
| CE6 | HDPE5 | 110 | 0.2 | 550 | Smooth | 250 | 149 | 1.3 | NS | 0% | No | Fail | — |
| E6 | HDPE5 | 110 | 0.2 | 550 | Smooth | 250 | 149 | 1.3 | 9 | 116% | No | Pass | Pass |
| E7 | HDPE5 | 110 | 0.2 | 550 | Smooth | 150 | 149 | 1.3 | 5 | 122% | No | Pass | Pass |
| CE7 | INFUSE ™ 9817 | 41 | 1.6 | 25.6 | Ribbed | 150 | 177 | 4.9 | NS | 0% | No | Fail | — |
| | INFUSE ™ 9817 | 41 | 1.6 | 25.6 | Ribbed | 150 | 177 | 4.9 | 3 | 150% | No | Fail | — |
| E8 | INFUSE ™ 9817 | 41 | 1.6 | 25.6 | Ribbed | 150 | 177 | 4.9 | 4 | 150% | No | Pass | Pass |

Applicant discovered that utilization of the mandrel with expandable collar during the fitment heat seal procedure advantageously enables the use of fitment base having thin-wall structure. Thin-wall or thin-walling is the reduction of the wall thickness for the fitment base. Examples E2, E4, E5, E6, and E7 show that fitments with d/WT ratio from 35, or 54.7 (thin-wall), or 86.7 to 220 (thin-wall), or 550 (thin-wall) (i) can be successfully heat sealed to the neck of the flexible container, (ii) avoid deformation, (iii) pass the burst test, (iv) pass the hang test, and (v) simultaneously fulfill each of (i) through (iv).

Utilization of the mandrel with expandable collar during the fitment heat seal procedure also enables the use of polymeric materials not previously suitable for fitment applications. The mandrel with expandable collar supports the fitment during the sealing, and prevents deformation. Thus, the mandrel with expandable collar enables polymeric materials previously either too soft or too rigid (cracking) to now be used as fitments alone or thin-walled. Example E8 (with expandable collar) shows that INFUSE 9817, an elastomer, can be used as a suitable fitment material. Whereas comparative sample CE7 (INFUSE 9817) sealed without the expandable collar fails the burst test. Example E8 (i) is successfully heat sealed to the neck of the flexible container, (ii) avoids deformation, (iii) passes the burst test, (iv) pass the hang test, and (v) simultaneously fulfills each of (i) through (iv).

Utilization of the mandrel with expandable collar during the fitment heat seal procedure also enables shorter seal times without degrading seal strength. Example E3 (with expandable collar) yields an acceptable fitment seal (passing burst test and hang test) with 7 seconds seal time, while comparative sample CE3 (no expandable collar) requires 20 seconds to produce an acceptable fitment seal.

The mandrel with expandable collar enables greater seal pressure to be applied to the fitment. Example E2 (with expandable collar) yields an acceptable fitment seal (passing burst test and hang test) at 4.9 seal bar pressure, whereas comparative sample CE2 at 4.9 seal bar pressure is permanently deformed.

Applicant unexpectedly found that the mandrel with expandable collar enables the production of a four-panel flexible container with a hermetically sealed fitment wherein the base wall thickness is from 0.2 mm, or 0.5 mm to 0.75 mm (thin-wall base).

It is specifically intended that the present disclosure not be limited to the embodiments and illustrations contained herein, but include modified forms of those embodiments including portions of the embodiments and combinations of elements of different embodiments as come with the scope of the following claims.

1. A process comprising:
(A) providing a flexible container having
(i) a body, and
(ii) a neck;
(B) positioning a fitment into the neck, the fitment comprising a top portion and a base, the fitment composed of a polymeric material;
(C) inserting a mandrel into the fitment, the mandrel comprising an expandable collar composed of an elastomeric material;
(D) expanding the expandable collar radially outward to contact an inner surface of the base; and
(E) sealing, with a pair of opposing seal bars, the base to the neck.

2. The process of claim 1 wherein the mandrel further comprises a mandrel base, a nosecone, and a pull bar, the expandable collar is disposed between the base and the nosecone, the pull bar extends through a channel in the base and in the expandable collar, the pull bar attached to the nosecone, the expanding comprising
retracting the pull bar; and
compressing the expandable collar between the mandrel base and the nosecone.

3. The process of claim 2 comprising retracting the pull bar to produce a radially expanded diameter for the expandable collar.

4. The process of claim 2 wherein the expandable collar has a relaxed diameter, the process comprising retracting the pull bar and compressing the expandable collar to produce a radially expanded diameter that is from 1% to 200% greater than the relaxed diameter.

5. The process of claim 2 wherein the compressing produces a radially expanded collar having a thickness that is greater than or equal to the width of each seal bar.

6. The process of claim 1 comprising:
supporting, during the sealing, the base with the radially expanded collar; and
preventing, with the radially expanded collar, deformation of the fitment during the sealing.

7. The process of claim 1 comprising providing a flexible container comprising four panels, each panel comprising a flexible multilayer film comprising of a polymeric material.

8. The process of claim 1 comprising providing a flexible container comprising two panels, each panel comprising a flexible multilayer film comprising of a polymeric material.

9. The process of claim 1 wherein the sealing comprises:
first sealing, with a first pair of opposing seal bars in a first orientation, the fitment to the neck portion; and
second sealing, with a second pair of opposing seal bars in a second orientation, the fitment to the neck portion.

10. The process of claim 9 comprising:
contacting an inner surface of the base with the radially expanded collar along a length of the base; and
supporting the base with the expanded collar during the first sealing and during the second sealing.

11. The process of claim 10 comprising positioning a fitment into the neck and the base has a diameter that is greater than the diameter of the top portion.

12. The process of claim 11 comprising positioning a fitment into the neck, the fitment having a diameter (d) to wall thickness (WT) ratio, d/WT, from 35 to 800.

13. The process of claim 12 comprising forming a hermetic seal between the neck portion and the fitment.
